(19) United States
(12) Patent Application Publication
(10) Pub. No.: US 2003/0063886 A1
(43) Pub. Date: Apr. 3, 2003

(54) Methods for thermal control of optical components

(76) Inventors: Lowell Seal, Reisterstown, MD (US); Steven Brown, Crownsville, MD (US); Ramesh Varma, Columbia, MD (US); Ronald E. Johnson, Pasaden, MD (US); Jeffrey Lynch, College Park, MD (US)

Correspondence Address: FOLEY AND LARDNER, SUITE 500, 3000 K STREET NW, WASHINGTON, DC, 20007, US

(21) Appl. No.: 09/969,029

(22) Filed: Oct. 3, 2001

(51) Int. Cl. G02B 6/00

(52) U.S. Cl. 385/134

(57) ABSTRACT

A method of controlling a package of optical components includes providing a thermally conductive layer for mounting optical components. A temperature proximate to the optical components is sensed. The optical components are heated or cooled in response to the sensed temperature by activating a temperature alternation device.

### BACKGROUND OF THE INVENTION

1. Field of the Invention

The present invention relates generally to thermal control of optical packages in an optical unit. More specifically, the present invention relates to a method activating a temperature alteration device to reliably control the temperature of the optical package.

2. Background of the Related Art

Many optical components are temperature sensitive. For example, most gratings, such as Fiber Bragg Gratings, are sensitive to temperature since their operational characteristics shift with changes in the temperature. Accordingly, in the prior art, the packages for optical components attempt to maintain the optical components at a constant temperature, or to constrain them such that they are insensitive to temperature variations.

In one of the techniques in the prior art, athermal packaging is used to provide temperature insensitivity of the optical components contained within the package. Athermal packaging makes use of the fact that materials expand or shrink when heated and cooled. This expansion and shrinkage is what causes the changes in the characteristics of the device. Athermal packaging makes use of a combination of materials with different expansion and shrinkage coefficients so that the expansion and shrinking of the combination of materials counteract each other so that the effective change is minimized. In this way, athermal packages minimize the effects of temperature changes on optical components contained in the packages.

However, athermal packages are generally very expensive since they require specific combinations of materials that provide counteracting expansion and shrinkage. Furthermore, the combination of materials needed for an athermal package tends to make the athermal packages rather bulky in addition to being expensive. With the increasing density of optical components, the bulkiness of the athermal package becomes even more of a problem.

Attempts to heat or cool thermal packages have generally not succeeded because of problems associated with the precise control of the temperature that is required in the packages since the optical components are often very temperature sensitive. Any failure of the heating or cooling devices could damage the optical components in the package. Even small changes in temperature could alter the characteristics of the optical components so that they do not function optimally and thereby degrade the performance of the optical systems in which the optical components may be used.

Therefore, there is a need for an optical package that can actively control the temperature in the package so that the optical components can perform optimally. Furthermore, there is a need for the temperature controlled optical package to be reliable and cost effective. Furthermore, the optical package should also not be bulky so that the density of optical components can be increased.

### SUMMARY OF THE INVENTION

In one aspect, the present invention provides a method of thermally controlling a package for optical components, including the steps of: providing a thermally conductive layer for mounting the optical components; sensing a temperature proximate to the optical components; and activating a temperature alteration device to heat or cool the optical components in response to the sensed temperature.

In a further aspect, the method includes providing a control circuit for activating the temperature alteration device.

In a further aspect, the method includes providing redundant elements within the control circuit and/or the temperature alteration device. In this aspect, the step of providing redundant elements includes providing m elements within the control circuit and/or temperature alteration device when n operational elements are needed to provide n by m element redundancy.

In one aspect of the present invention, the method further includes: operating n elements of the control circuit and/or control device; detecting a failure of one of the n elements; and activating one of the (m-n) elements upon detecting a failure of one of the n elements.

In one aspect, the method of the present invention includes providing a heat spreader between the temperature alteration device and the thermally conductive layer.

In another aspect, the method of the present invention includes encapsulating the thermally conductive layer, the temperature alteration device, and the heat spreader with an insulator.

In another aspect, the method includes encapsulating the thermally conductive layer, heat spreader, and the insulator with a low thermal conductivity outer package that is designed to enable formation of air pockets around the outer package.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is an exploded assembly of the optical package consistent with an embodiment of the present invention.

FIG. 2 is a circuit diagram of one embodiment of the temperature control circuit consistent with the present invention.

FIG. 3 is a circuit diagram of another embodiment of the temperature control circuit consistent with the present invention.

FIG. 4 is a table illustrating exemplary combination of failures of circuit elements that would result in underheat or overheat conditions of the package.

FIG. 5 is block diagram illustrating optical units that include optical packages according to the present invention.

### DESCRIPTION OF THE PREFERRED EMBODIMENT(S)

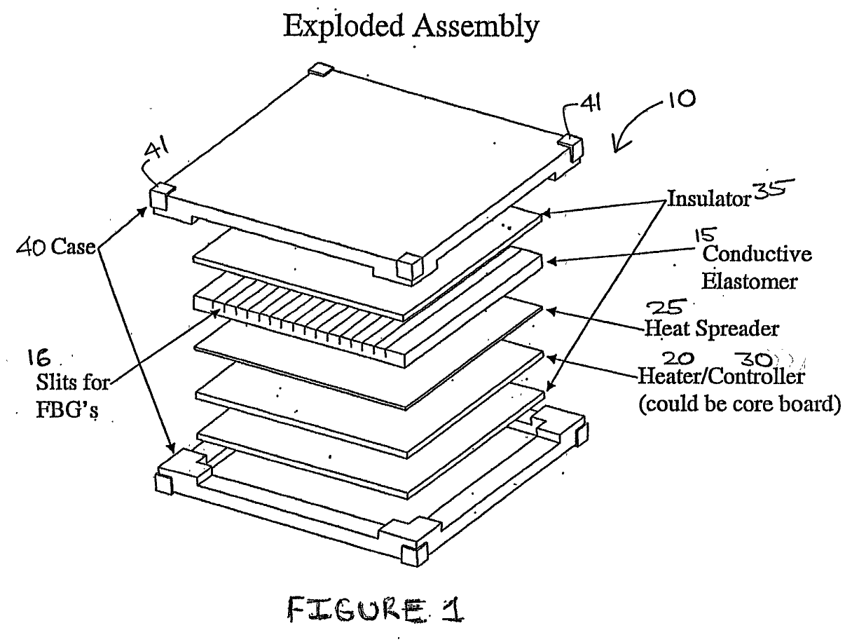

FIG. 1 is an exploded assembly of an optical package 10 consistent with a preferred embodiment of the present invention. FIG. 1 is merely an illustration and should not limit any of the claims herein. One of ordinary skill in the art would recognize other variations, modifications, and alternatives based on the disclosure herein.

The optical package 10 includes a thermally conductive layer 15, such as a conductive elastomer, that is used to mount the optical components therein. For example, slits 16 could be provided in the thermally conductive layer 15 for mounting optical components, such as Fiber Bragg Gratings. One of skill would recognize that Fiber Bragg Gratings are an exemplary optical component that could be mounted in the thermally conductive layer 15. The present invention contemplates that other optical components, such as without limitation, other gratings, polarizers, filters, multiplexers, or beam splitters could also be mounted in the thermally conductive layer 15 for suitable applications that may require these optical components.

The thermally conductive layer 15 is preferably a conductive elastomer or other material that is soft and compliant and does not impose any unnecessary stress or strain on the optical fiber or component. In one embodiment, the conductive elastomer is a silicone based elastomer with thermally conductive particles, such as alumina, embedded therein to enhance the thermal conductivity of the elastomer. Other examples of thermally conductive particles that can be added to improve conductivity include without limitation—boron nitride, carbon powder, carbon fibers, and/or aluminum oxide. One such commercially available elastomer is sold by Furon Co. as TC2XXX, where XXX is the thickness. By employing a compliant material with slits for mounting the optical components, thermal expansion mismatch is reduced to zero. The friction fit between the optical components and the compliant material allows for relative movement therebetween so that the components are not stressed due to temperature variations within the package.

A temperature alteration device 20, is arranged adjacent to the thermally conductive layer 15 and the optical component(s) mounted thereon, so that the temperature alteration device 20 can alter the ambient temperature around the optical components to an optimal temperature for the operating characteristics of the optical components. In one embodiment, the temperature alteration device 20 is a heater that generates heat to raise the ambient temperature. In another embodiment, the temperature alteration device 20 can be cooling device, such as a thermoelectric cooling device, that cools the environment around the optical components. Alternatively, the temperature alteration device 20 could include both a heater and a cooling device, such that a controller could selectively operate either the heater or the cooling device to raise or lower the ambient temperature around the optical components.

With a heater as the temperature alteration device 20, a heat spreader 25 is provided between the heater 20 and the thermally conductive layer 15 so that the heat generated by the heater 20 is evenly applied to the thermally conductive layer 15 and to the environment of the optical components mounted therein. Since smaller sizes are preferred, in one embodiment, the heater module is approximately 70 mm×70 mm×2 mm (thick) to generate sufficient heat for a optical package 10 containing up to 16 Fiber Bragg Gratings in a terminal unit for a fiber optic data transmission application.

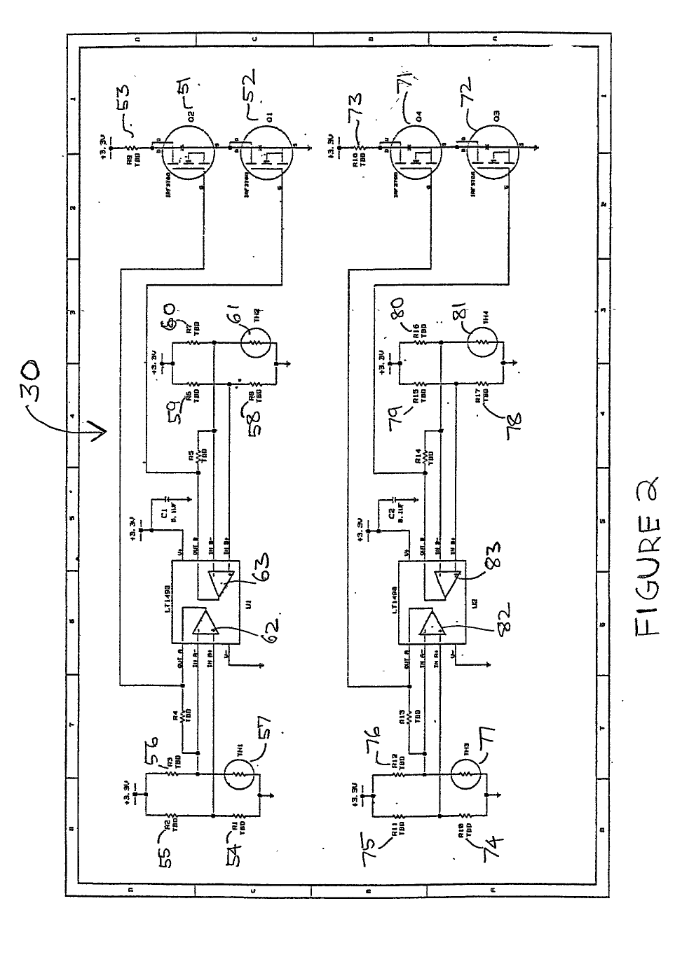

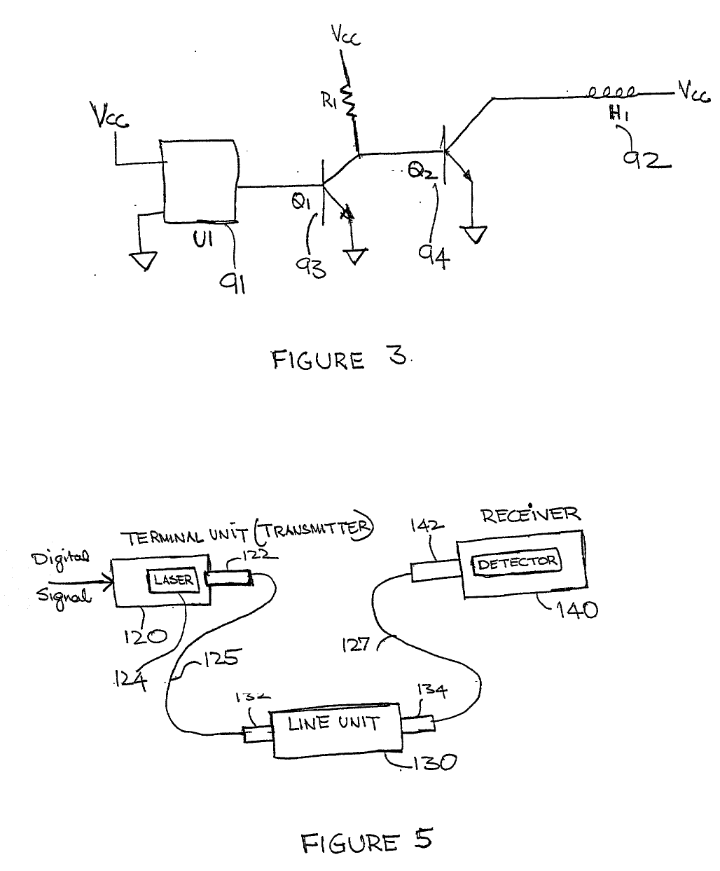

A controller 30 is also provided to control the heating and cooling provided by the temperature alteration device 20. In one embodiment, the controller 30 is preferably provided on the same board on which the temperature alteration device 20 is provided so that they can be efficiently coupled together. Alternative designs of the controller 30 are discussed further herein with respect to FIGS. 2 and 3.

An insulator 35 is provided to encapsulate the thermally conductive layer 15 (with the optical components mounted thereon), the temperature alteration device 20, the controller 30, and the heat spreader 25. The insulator 35 serves to insulate the environment around the optical components from the temperature changes in the environment surrounding the optical package 10. One skilled in the art would recognize that many different materials may be used for the insulator 35. For example, the insulator 35 may be made of open cell foam.

An external casing (or outer package) 40 is also provided to encapsulate the insulator 35, the thermally conductive layer 15 with the optical components mounted thereon, the heat spreader 25, the heater 20, and the controller 30. The external casing 40 further isolates the optical package 10 from the surrounding environment. In one aspect of the present invention, the external casing 40 is preferably designed so that air pockets are trapped between the external casing 40 and the other components of the optical package 10.

These air pockets provide additional insulation to the optical package 10 from the surrounding environment. One skilled in the art would recognize that such air pockets can be formed by several methods. For example, the mating surfaces of the external casing 40 and the rest of the optical package 10 can be irregularly shaped (for example, with indentations) so that air pockets are formed when the external casing 40 is mated with the rest of the optical package 10. Furthermore, external casing 40 may also be provided with bumps 41 at each corner so that a thin insulative film of air is trapped when the optical packages 10 are stacked together

For exemplary embodiments of the present invention where a thermoelectric cooling device is employed as the temperature alteration device 20 instead of a heater, the heat spreader 25 would be replaced by a conductor having high performance thermal conducting properties to cool the optical components. Likewise, an additional “heat sink” or plate (not shown) would replace insulator 35.

FIG. 2 is a circuit diagram of an exemplary temperature controller 30 that controls the heating/cooling of the optical components by the temperature alteration device 20. FIG. 2 is merely an illustration and should not limit any of the claims herein. One of ordinary skill in the art would recognize other variations, modifications, and alternatives based on the disclosure herein. As discussed earlier, the controller 30 and the heating or cooling device can preferably be located on the same board so that they can be efficiently coupled together. This embodiment of the controller 30 implements a thermistor based proportional control by which the amount of heat generated by the heating element is proportional to the temperature change desired. Therefore, a temperature is detected by the controller 30 so that if the detected temperature is close to the set point temperature, only a small amount of power is provided to the heating elements so that a relatively small amount of heat is generated by the heating elements. On the other hand, if the measured temperature is considerably different from the set point temperature, more power is provided to the heating elements so that relatively more heat is generated by the heating elements. It should be noted that the set point temperature of the controller is designed in accordance with the desired temperature for the optical components so that no power is provided to the heating elements at the set point temperature.

FIG. 3 illustrates a thermostat-based on/off control which simply switches the heating element on and off based on a sensed temperature difference so that the heating element generates a constant amount of heat when it is switched on.

The controller 30 and the temperature alteration device 20 are, preferably implemented with element redundancy, which minimizes overheat and underheat conditions and greatly reduces the probability of catastrophic failure of controlled temperature alteration. This is useful since many optical components are temperature sensitive and even relatively small shifts in the temperature can alter the operational characteristics of the optical components. Significant shifts of the temperature can cause severe damage to the optical components.

As seen in the circuit diagram of FIG. 2, the controller 30 has two duplicate portions: a first portion with circuit elements 51-63 and a second portion with circuit elements 71-83. Furthermore, each of the first portion and the second portion have two separate heating elements controlled by separate thermistor based wheatstone bride circuits so that additional redundancy is provided. Therefore, in the first portion of the circuit, the thermistor 57 is arranged in the wheatstone bridge that also includes resistors 54-56. The wheatstone bridge is coupled to an operational amplifier 62 to control transistor 51 which is a heating element. The thermistor 61 is arranged in the wheatstone bridge that also includes resistors 58-60. The wheatstone bridge is coupled to the operational amplifier 63 to control the transistor 52 which is a separate heating element connected in series to the transistor 51 and a resistive heater 53.

Likewise, the second portion also includes two separate heating element control circuits that control two separate heating elements. The thermistor 77 based wheatstone bridge 74-77 is coupled to the operational amplifier 82 to control the transistor 71, which is a heating element, while the thermistor 81 based wheatstone bridge 78-81 is coupled to operational amplifier 83 to control the transistor 72 which is also a heating element. One skilled in the art would recognize that thermistors are thermally sensitive resistors whose characteristics exhibit large changes in resistance with a small change in temperature and can be used to provide proportional temperature control. Likewise, the use of a wheatstone bridge to detect small changes in a resistance transducer (such as the thermistor) for control proportional to the detected change is well known to those skilled in the art.

FIG. 3 is a circuit diagram that illustrates an alternate embodiment of the controller 30 that provides thermostat based on/off control. FIG. 3 is merely an illustration and should not limit any of the claims herein. One of ordinary skill in the art would recognize other variations, modifications, and alternatives based on the disclosure herein. In this type of control, the heating element 92 is turned on by providing a constant amount of power once the thermostat 91 detects a certain temperature difference threshold from the set point temperature. The heating element 92 then continues operating at the same power level until the thermostat 91 detects that the temperature difference has fallen below the temperature difference threshold. In FIG. 3, element 93 is preferably a small signal bipolar transistor, while element 94 is preferably a power MOSFET. One skilled in the art would recognize that many equivalent thermostat-based control circuits could be used to implement the thermostat based control discussed herein.

As discussed earlier, FIG. 2 discloses a controller 30 and temperature alteration device 20 configuration that provides a “1 by 2” redundancy since the first portion and the second portion are essentially duplicates. Furthermore, each of the first and second portions have redundant portions themselves so that this configuration can be used to provide “1 by 4” and “3 by 4” redundancy as well. Therefore, it is possible to achieve “n by m” redundancy such that n operational elements out of m provided element provide sufficient temperature alteration (for example, heating) by appropriately determining the maximum heat to be generated by each of the m elements. That is, under heating can be prevented as long as n of the m elements are operational. Likewise, overheating can also be minimized or prevented by increasing “n” since that would reduce the heat generated by each element. As a result, a malfunctioning element (stuck in the on position, for example) would generate less heat and thus minimize the overheating.

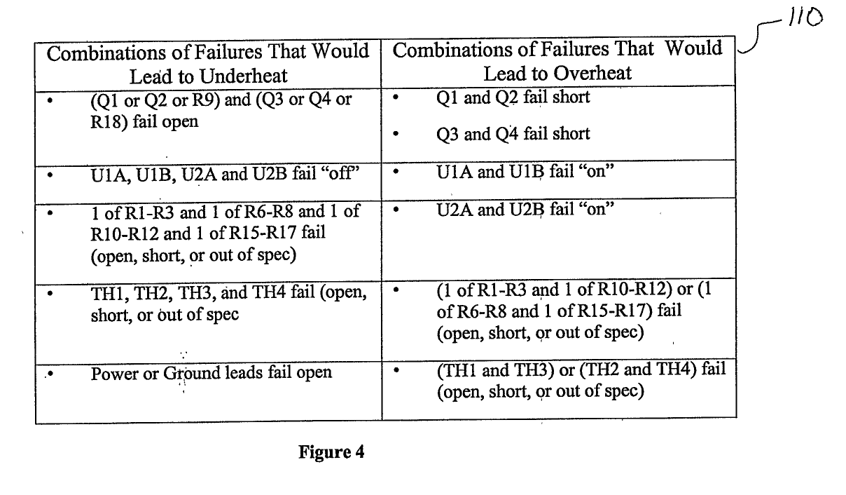

As one method of designing the extent of redundancy, the probabilities of overheating and underheating conditions can be calculated based on the overheat and underheat conditions disclosed, for example, in table 110 in FIG. 4. The circuit elements in table 110 refer to the corresponding elements shown in the circuit diagram of FIG. 2. Therefore, based on the probability of the respective conditions (calculated, for example, based on known circuit element failure rates), the appropriate redundancy can be built in to minimize the probability of overheat and underheat conditions. Additionally, space and weight constraints may limit the extent of the redundancy that can be built in. Therefore, one embodiment, for an optical package used in either a line unit or a terminal unit of a data transmission fiber optic network, 4 by 6 element redundancy may be used.

FIG. 5 is a block diagram illustrating optical units that are used in a data communication fiber optic network. FIG. 5 is merely an illustration and should not limit any of the claims herein. One of ordinary skill in the art would recognize other variations, modifications, and alternatives based on the disclosure herein. Terminal units 120 and 140 are connected by fiber optic cables 125 and 127 through a line unit 130. One skilled in the art would recognize that several line units 130 may be provided between the terminal units 120 and 140. Terminal unit 120 may use a plurality of lasers 124 (for example, pump lasers) which are modulated to generate optical data signals that are transmitted to the optical fiber 125 through a coupling unit 122 that couples the terminal unit 120 to the optical fiber 125. One skilled in the art would recognize that the signal would be transmitted after appropriate processing steps, such as, error correction and multiplexing (for example, using WDM or DWDM).

The line unit 130 is coupled to the optical fiber 125 through a coupling unit 132 and to the optical fiber 127 through another coupling unit 134. The line unit 130 regenerates or amplifies the optical data signal using a plurality of lasers (not shown). Terminal unit 140 is coupled to the fiber optic cable 127 through a coupling unit 142 and can receive from and transmit signals to the terminal unit 120. Each of these optical units (terminal unit or line unit) can include optical packages 10 as discussed earlier herein. For example, in line unit 120 the optical packages 10 could be used in the plurality of lasers 124 or in the coupling unit 122.

Other embodiments of the invention will be apparent to those skilled in the art from a consideration of the specification and the practice of the invention disclosed herein. It is intended that the specification be considered as exemplary only, with the true scope and spirit of the invention being indicated by the following claims.

What is claimed is:

1. A method of thermally controlling a package for optical components, comprising the steps of:
providing a thermally conductive layer for mounting the optical components;
sensing a temperature proximate to the optical components; and
activating a temperature alteration device to heat or cool the optical components in response to the sensed temperature.

2. The method according to claim 1, further comprising providing a control circuit for activating the temperature alteration device.

3. The method according to claim 2, further comprising providing redundant elements within the control circuit and/or the temperature alteration device.

4. The method according to claim 3, wherein the step of providing redundant elements includes providing m elements within the control circuit and/or temperature alteration device where n operational elements are needed to provide n by m element redundancy.

5. The method according to claim 4, further comprising:
operating the n elements of the control circuit and/or temperature alteration device;
detecting a failure of one of the n elements; and
activating one of the (m-n) elements upon detecting a failure of one of the n elements.

6. The method according to claim 1, further comprising:
providing a heat spreader between the temperature alteration device and the thermally conductive layer.

7. The method according to claim 6, further comprising:
encapsulating the thermally conductive layer, the temperature alteration device, and the heat spreader with an insulator.

8. The method according to claim 7, further comprising:
encapsulating the thermally conductive layer, heat spreader, and the insulator with a low thermal conductivity outer package that is designed to enable formation of air pockets around the outer package.

9. The method of claim 5, wherein n is 1 and m is 2.

10. The method according to claim 5, wherein n is 4 and m is 6.

11. The method according to claim 1, wherein said temperature alteration device comprises a heater that heats the optical components.

12. The method according to claim 11, further comprising providing a control circuit for activating the heater.

13. The method according to claim 12, further comprising providing redundant elements within the control circuit and/or the heater.

14. The method according to claim 13, wherein the step of providing redundant elements includes providing m elements within the control circuit and/or heater where n operational elements are needed to provide n by m element redundancy.

15. The method according to claim 14, further comprising:
operating the n elements of the control circuit and/or heater;
detecting a failure of one of the n elements; and
activating one of the (m-n) elements upon detecting a failure of one of the n elements.

16. The method according to claim 11, further comprising:
providing a heat spreader between the heater and the thermally conductive layer.

17. The method according to claim 16, further comprising:
encapsulating the thermally conductive layer, the heater, and the heat spreader with an insulator.

18. The method according to claim 17, further comprising:
encapsulating the thermally conductive layer, heat spreader, and the insulator with a low thermal conductivity outer package that is designed to enable formation of air pockets around the outer package.

19. The method of claim 15, wherein n is 1 and m is 2.

20. The method according to claim 15, wherein n is 4 and m is 6.

21. The method according to claim 1, wherein the temperature alteration device is a thermo electric cooling device that cools the optical components.

22. The method according to claim 21, further comprising providing a control circuit for activating the thermo electric cooling device.

23. The method according to claim 22, further comprising providing redundant elements within the control circuit and/or the thermo electric cooling device.

24. The method according to claim 23, wherein the step of providing redundant elements includes providing m elements within the control circuit and/or thermo electric cooling device where n operational elements are needed to provide n by m element redundancy.

25. The method according to claim 24, further comprising:
operating the n elements of the control circuit and/or thermo electric cooling device;
detecting a failure of one of the n elements; and
activating one of the (m-n) elements upon detecting a failure of one of the n elements.

26. The method of claim 25, wherein n is 1 and m is 2.

27. The method according to claim 25, wherein n is 4 and m is 6.
